(19) United States
(12) Patent Application Publication
(10) Pub. No.: US 2016/0081377 A1
(43) Pub. Date: Mar. 24, 2016

(54) Process For Making Microwaveable, Sugar-Free, Grain-Textured Milk And Cereal Bars And Finger-Foods Whereby Every Serving Can Be Eaten Completely Interchangeably With And Priced Competitively With A Bowl of Milk And Cereal

(71) Applicants: Rachel B. Zukerman, Northbrook, IL (US); Harold W. Zukerman, Northbrook, IL (US)

(72) Inventors: Rachel B. Zukerman, Northbrook, IL (US); Harold W. Zukerman, Northbrook, IL (US)

(21) Appl. No.: 14/493,996

(22) Filed: Sep. 23, 2014

(51) Int. Cl. A23L 1/164

(52) U.S. Cl. CPC A23L 1/1643; A23V 2002/00

(57) ABSTRACT

The present invention relates to a process for making milk and cereal bars and finger-foods; said process comprising the steps of: a) modifying raw, whole cereal grains so they become fully-cooked within 30 minutes; b) partially cooking every one to four ounces of modified cereal grains with every one half-cup of fluid-milk at 210° F. and discharging them from the cooker before the starch-granules in the grain-centers are gelatinized; c) depositing said partially-cooked grains into continuous sheets which are then cut into units; d) heating the units of c) with 450° F. blown-air in a convection-oven, and discharging said units from the oven either before or after the starch-granules in the grain-centers have become gelatinized; and e) freezing said units.

### BACKGROUND OF THE INVENTION

Forty years ago, when dry cereal bars were first sold in supermarkets, breakfast consumers of that era, who did not have time to eat a bowl of milk and cereal at home, ate chocolate candy bars in their cars on the way to work. They rejected the dry, shelf-stable cereal bars that were offered at that time because their textures were too hard. That is why the cereal companies needed to make softer-textured, shelf-stable cereal bars using the process taught in U.S. Pat. No. 4,022,915A issued on May 10, 1977 to Harold Zukerman, who is also the author of the present invention. U.S. Pat. No. 4,022,915A teaches how to make softer-textured cereal based foods by adding extra fat and water. However, the amount of extra water needed to make the cereal-based foods softer was higher than 12%. Before prior art U.S. Pat. No. 4,022,915A was issued, all the dry cereal-based foods that were positioned on the supermarket shelves were made with moisture levels that were lower than 10% so they wouldn't spoil. U.S. Pat. No. 4,022,915A taught a different technique. Softer textured cereal-based foods having moistures higher than 12% moisture could be positioned on the supermarket shelves if they were also made with large amounts of soluble-solids from ingredients such as sugar, corn syrup and/or glycerin which lowered their water-activities to below 0.85 thereby making them shelf-stable. This technique is now used for making granola bars, cereal bars and milk and cereal bars.

Prior art Kellogg's Milk and Cereal Bars and General Mills' Milk 'n Cereal Bars are made by extruding a dry cereal flour mixture (containing large amounts of sugar, corn syrup and hard fat) through a continuous-cooker-extruder to make low-density cereal shapes. Said cereal shapes are enrobed with a binder so they stick to one another and are formed into a sheet which is then cut into bars. These high sugar shelf-stable cereal bars have water-activities that are lower than 0.85 and moistures between 12 and 20%.

Prior art Quaker Oats' Granola Bars are made by mixing rolled oats with either a glycerin preservation system or a high-sugar and corn syrup preservation system. Quaker Oats' shelf-stable cereal bars have water-activities that are lower than 0.85 and moistures that are lower than 20%.

Prior art Kraft Foods' Milk and Granola Bars have grain-textures which are made with rolled oats that are mixed and cooked with a creamy sugar-syrup comprised of cream from milk and skim milk, sugar, inulin and raisins which are deposited as a sheet, cut into bars and baked. Milk and Granola Bars are made with large amounts of sugar, have water-activities lower than 0.85 and moistures lower than 20%.

Prior art U.S. Pat. No. 6,103,283 teaches a process for making milk and cereal bars. The '283 process requires that all the raw, whole cereal grains be “fully-cooked” in the cooker, the first step in the process. The problem is that white rice grains require a 30 minute cook-time to become fully-cooked, whereas, raw whole oat and wheat grains require an 80 minute cook-time to become fully-cooked. However, because the '283 patent requires all three grain genera to be cooked together for 80 minutes, the white rice grains are over-cooked and have completely lost their grain-texture by the time the oat and wheat grains are fully-cooked. Although the soft-textured, “fully-cooked” grains are perfect for eating, their texture is too soft for forming into units. That is why the fully-cooked grains of the '283 process become mashed, fractured and develop a homogeneous-consistency. Then, said units are oven-baked at 400 F for an additional 12 minutes. To summarize, the '283 process produces over-cooked milk and cereal bars in 1½ hours.

The milk and cereal bars of the present invention are produced within 30 minutes, that is three times faster than the '283 process. The faster process of the present invention is accomplished by first modifying all the whole raw cereal grains that take longer than 30 minutes to become fully-cooked so they can become fully-cooked within 30 minutes. Said modified raw cereal grains cook faster because they have a larger surface area which absorbs the hot fluid-milk from the batch-cooker at a faster rate and in a shorter period of time. Said modified raw cereal grains also have a shorter distance between their surface areas and their grain-centers. This shorter distance allows the infused hot fluid-milk from the modified grains' surface areas to diffuse twice as fast through the grains' interiors and then into their grain-center. When the grain-centers become gelatinized, the milk and cereal bars and finger-foods are fully-cooked.

The process of the present invention makes both milk and cereal bars in which the grains are fully-cooked, and also milk and cereal bars in which the grains are not fully-cooked. The frozen fully-cooked milk and cereal bars are for hurried-consumers who take them from the refrigerator after having been defrosted, and eat them without any additional preparation; whereas, frozen milk and cereal bars made with grains that are not fully-cooked have better retained grain-textures and are baked for a shorter period of time. Microwaveable grain-textured milk and cereal bars made with fluid-milk-infused cereal grains that are not fully-cooked in the plant are ideal for the process of the present invention because microwave ovens provide unique cooking properties, they are able to rapidly cook and gelatinize the uncooked starch-granules in the grain-centers of the frozen milk and cereal bars and finger-foods while they are re-heated.

There is another difference between the '283 process and the process of the present invention. The milk and cereal bars made with the '283 process cannot be priced competitively with bowls of milk and cereal because they are made with a 1½ hour process and also with expensive processed milk products: dried milk-solids, concentrated milk and pasteurized fluid-milk; whereas, the milk and cereal bars of the process of the present invention can be priced competitively with bowls of milk and cereal because they are made with a 30 minute process and food commodities: raw, uncooked fluid-milk and raw cereal grains.

Prior art cereal bar snacks such as granola bars, cereal bars and milk and cereal bars made with large amounts of sugar, corn syrup and hard fat are shelf-stable, have softer-textures, moistures higher than 12% and provide sugar-surges like candy bars. When recent medical reports linked foods made with large amounts of sugar, corn syrup and hard-fat like cereal bars to increased risks for obesity, type 2 diabetes and heart disease, health-conscience breakfast consumers and children abandoned said prior art granola bars, cereal bars and milk and cereal bars. To meet the needs of health-conscious breakfast consumers and children, the process of the present invention was developed to make sugar-free and low sugar, grain-textured milk and cereal bars and finger-foods with a half-cup of fresh un-pasteurized fluid-milk for every one to four ounces of raw cereal grains so that every finished product serving can be eaten interchangeably with and priced competitively with a bowl of milk and cereal.

### BRIEF SUMMARY OF THE INVENTION

The present invention relates to a process for making microwaveable, sugar-free, grain-textured milk and cereal bars and finger-foods with a half-cup of fresh un-pasteurized fluid-milk for every one to four ounces of raw cereal grains so every finished product serving can be eaten interchangeably with and priced competitively with a bowl of milk and cereal; said process comprising the steps of: a) modifying all the raw whole cereal grains that take longer than 30 minutes to become fully-cooked by either: cutting them into grain-halves. flattening them so they are half as thick or removing their surface bran-layer so they can become fully-cooked within 30 minutes; b) cooking every one to four ounces of raw, modified and unmodified cereal grains with every one half-cup of un-pasteurized fluid-milk at 210 F until said fluid-milk is pasteurized and infused into the surface areas of the grains, thereby making sticky-surfaced, partially-cooked, milk-infused cereal grains which are then discharged from the cooker before said fluid-milk diffuses into and gelatinizes the starch-granules in the grain-centers; c) depositing said partially-cooked grains having grain-centers that are not gelatinized, into continuous sheets which are then cut into units; d) heating with 450 F blown-air in a continuous convection-oven, said units comprised of partially-cooked grains, so that the infused fluid-milk from the surface areas of the grains diffuses into and continues cooking the grains while their moisture levels are simultaneously reduced, but remain higher than 25%, and then discharging said units from the oven either before the starch-granules in the grain-centers become gelatinized or after the starch-granules in the grain-centers have become gelatinized; and e) freezing said units.

It is the primary object of the present invention to provide a 30 minute process for making sugar-free and low-sugar, grain-textured milk and cereal bars and finger-foods with a half-cup of fresh, un-pasteurized fluid-milk for every one to four ounces of raw cereal grains so every serving can be eaten interchangeably with and can be priced competitively with a bowl of milk and cereal.

It is another object of the present invention to provide a process for making microwaveable, sugar-free and low sugar, grain-textured milk and cereal bars and finger-foods whereby the starch-granules in the grain-centers are not gelatinized before the units are frozen but become gelatinized when reheated in a microwave oven.

It is another object of the present invention to provide a process for making fully-cooked sugar-free and low-sugar, grain-textured milk and cereal bars and finger-foods whereby the starch-granules in the grain-centers of the products are gelatinized in the oven before the units are frozen so said frozen, fully-cooked milk and cereal bars can be eaten after having been defrosted without any additional preparation.

It is another object of the present invention to provide a process for making healthier, sugar-free, and low-sugar, grain-textured milk and cereal bars and finger-foods for the health-conscience breakfast consumers and children who have abandoned cereal bar snacks because medical reports are now linking foods made with large amounts of sugar, corn syrup and hard fat to increased risks for obesity, type 2 diabetes and heart disease.

### DETAILED DESCRIPTION OF THE PREFERRED EMBODIMENT

The present invention relates to a process for making microwaveable, sugar-free, grain-textured milk and cereal bars and finger-foods with a half-cup of fresh un-pasteurized fluid-milk for every one to four ounces of raw cereal grains so every finished product serving can be eaten interchangeably with and priced competitively with a bowl of milk and cereal; said process comprising the steps of: a) modifying all the raw whole cereal grains that take longer than 30 minutes to become fully-cooked by either cutting them into grain-halves, flattening them to half their thickness or removing their surface bran so they can become fully-cooked within 30 minutes; b) cooking every one to four ounces of raw, modified and unmodified cereal grains with every one half-cup of un-pasteurized fluid-milk at 210 F until said fluid-milk is pasteurized and infused into the surface areas of the grains, thereby making sticky-surfaced, partially-cooked, milk-infused cereal grains which are then immediately dumped from the cooker before said fluid-milk diffuses into and gelatinizes the un-cooked starch-granules in the centers of the grains; c) depositing said partially-cooked grains having uncooked grain-centers, into continuous sheets which are then cut into units; d) heating with 450 F blown-air in a continuous convection-oven, said units comprised of partially-cooked grains, so that the infused fluid-milk from the surface areas of the grains diffuses into and continues cooking the grains while their moisture levels are simultaneously reduced, but remain higher than 25%, and then discharging said units from the oven either before the starch-granules in the grain-centers become gelatinized or after the starch-granules in the grain-centers have become gelatinized; and e) freezing said units.

The process of the present invention makes both milk and cereal bars in which the grains are fully-cooked, and also milk and cereal bars in which the grains are not fully-cooked. Said frozen fully-cooked milk and cereal bars are for hurried-consumers who take them from the refrigerator after having been defrosted, and eat them without any additional preparation; whereas, frozen milk and cereal bars made with grains that are not fully-cooked have better retained grain-textures and need to be baked for a shorter period of time. Microwaveable grain-textured milk and cereal bars made with fluid-milk-infused cereal grains that are not fully-cooked are ideal for the process of the present invention because microwave ovens provide unique cooking properties: they are able to rapidly cook and gelatinize the uncooked starch-granules in the grain-centers of the frozen milk and cereal bars and finger-foods while they are re-heated.

In the process of the present invention, milk and cereal bars are produced three times faster than the milk and cereal bars produced by the process taught in prior art U.S. Pat. No. 6,103,283. The faster process of the present invention is accomplished by first modifying all the whole raw cereal grains that take longer than 30 minutes to become fully-cooked so they can become fully-cooked within 30 minutes. Said modified raw cereal grains cook faster because they have a larger surface area which absorbs the hot fluid-milk from the batch-cooker at a faster rate and in a shorter period of time. Said modified raw cereal grains also have a shorter distance between their surface areas and their grain-centers. This shorter distance allows the infused fluid-milk from the modified grains' surface areas to diffuse twice as fast through the grains' interiors and then into their grain-centers, thereby gelatinizing the starch-granules twice as fast.

An adult serving of milk and cereal bars and finger foods is meant to be comparable to, can be eaten interchangeably with and can be priced competitively with a bowl of milk and cereal. That is why the preferred milk to cereal ratio is a half-cup of unpasteurized fluid-milk for each one to two ounces of raw whole cereal grains. In the process of the present invention, the range is widened to a half-cup of unpasteurized fluid-milk for each one to four ounces of raw whole cereal grains because some consumers prefer a larger amount of cereal grains which provide better grain-textured products. The weight of each recommended serving size depends on the products' moisture loss during the oven-baking step.

Raw, whole cereal grains are the preferred cereal ingredient in the products of the present invention because they are inexpensive and are able to become infused with four times as much fluid-milk by weight without becoming soggy. Cereal grains are selected from the group consisting of rice grains, oat grains and wheat grains, and combinations thereof.

Raw un-pasteurized fresh, fluid-milk is the preferred milk ingredient because it is an inexpensive commodity product. Said raw milk becomes pasteurized when it is cooked with the cereal grains.

Starch and gum binders are used in the present invention to bind the individual cooked cereal grains to one another. In the process of the present invention, as the grains are partially-cooked in the cooker, soluble-starches and gums leach out from the modified grains' interiors into the hot fluid-milk and then become re-deposited onto the surfaces of the partially-cooked grains when the fluid-milk from the cooker is infused into the grains. These re-deposited soluble-starches and gums create the “sticky surfaces” that are needed to strongly bind the individual partially-cooked grains to one another. Because, some cereal grain genera do not provide enough starches and gums to make milk and cereal bars and finger-foods structurally strong enough to be picked up and eaten hand-held, commercial binders, waxy rice flour, water binders and CMC are sometimes added to the hot fluid-milk to supplement the natural starches and gums that are provided by the cereal grains.

In the process of the present invention, flavors such as fruit flavors, cheese, yogurt, vanilla, chocolate, sugar, sweeteners, herbs, spices, and combinations thereof can be added to the fluid-milk before the grains are added to the cooker. Because medical reports linked foods made with large amounts of sugar, corn syrup and hard fat to increased risks for obesity, type 2 diabetes and heart disease the products of the present invention are not formulated with large amounts of sugar, corn syrup and hard fat. However, small amounts of sugar and sweeteners can be used if desired as long as the water-activity of the product remains higher than 0.90

Starch-complexing agents are added to improve the freeze-thaw stability properties of the frozen milk and cereal bars and finger-foods. A blend of 85% distilled monoglycerides and 15% lecithin is dispersed with the hot, fluid-milk before the cereal grains are added to the cooker. Said monoglyceride-lecithin blend complexes the grains' starch as the hot fluid-milk from the cooker is infused into the grains. Starch complexing agents improve the milk and cereal bars freeze-thaw stability properties and add lubricity.

There are several ways to form milk and cereal bars and finger-food shapes without mashing and fracturing the milk-infused cereal grains.

One shaping technique forming shaped units by the following steps: a) dumping the entire batch of partially-cooked, modified cereal grains having uncooked grain-centers, from the batch cooker onto the continuous width of a three to six foot wide continuous conveyor-belt; b) moving said wide sheet of grains towards the cutters; c) reducing the height of said sheet of grains by compression with a large roll to a predetermined height; and d) cutting said sheet of grains into bar-shaped units with rotary and guillotine cutters.

A second shaping technique involves the use of a Double-Roll Former which extends across the entire width of a four to six foot wide conveyor-belt. The partially-cooked, modified cereal grains having uncooked grain-centers, are dumped onto the conveyor-belt which continuously deposits said cereal-grains into a hopper at a constant rate which continuously feeds two large rotating rolls, one rotating clock-wise while the other roll rotates counter clock-wise. This pumping action pushes said cereal grains through holes in a die plate and deposits them as continuous parallel strips comprised of milk-infused cereal grains with uncooked grain-centers. Said parallel strips are then cut into units with a guillotine cutter. This type of former is well known in the art and is readily available in the market place.

Milk and cereal bars and finger-foods comprised of partially-cooked milk-infused cereal grains having uncooked grain centers are then heated with 450 F blown-air in a continuous convection-oven, so the infused fluid-milk from the grains' surface areas diffuses into and cooks the grains while reducing their moistures, but not below 25%. The continuous convection oven needed for making the products of the present invention is well known in the art and is readily available in the market place.

The fully-cooked milk and cereal bars and finger-foods of the present invention can be eaten without any additional preparation. However, they can be frozen and stored frozen. The continuous freezers needed for the process of the present invention are well; known and readily available in the market place.

It is understood that the above described process is simply illustrative of the application of principles of the invention and many other modifications may be made without departing from the spirit and scope of this invention.

The embodiments of the invention in which an exclusive property or privilege is claimed as follows:

We claim:

1. A process for making grain-textured milk and cereal bars and finger-foods comprised of milk-infused cereal grains that have water-activities higher than 0.90 and moistures higher than 25%; said process comprising the steps of:
a) modifying all the raw whole cereal grains that take longer than 30 minutes to become fully-cooked by cutting them into grain-halves so they can become fully-cooked within 30 minutes;
b) cooking in a steam-jacketed, tilt-type kettle every one to four ounces of raw, modified and unmodified cereal grains with every one-half cup of un-pasteurized fluid-milk at 210 F until said fluid-milk is pasteurized and infused into the surface areas of the grains, thereby making sticky-surfaced, partially-cooked, milk-infused cereal grains which are then immediately dumped from the cooker before said fluid-milk diffuses into and gelatinizes the starch-granules in the centers of the grains;
c) depositing said partially-cooked grains with un-gelatinized grain-centers into continuous sheets which are then cut into units;
d) heating with 450 F blown-air in a continuous convection-oven, said units comprised of partially-cooked grains, so that the infused fluid-milk from the surface areas of the grains diffuses into and continues cooking the grains while their moisture levels are simultaneously reduced, but remain higher than 25%, and then discharging said units from the oven before the starch-granules in the grain-centers become gelatinized; and
e) freezing said units.

2. The process of claim 1 which further comprises modifying raw, whole cereal grains requiring cooking-times longer than 30 minutes to be fully-cooked by flattening them to half their grain thickness.

3. The process of claim 1 which further comprises modifying raw, whole cereal grains requiring cooking-times longer than 30 minutes to be fully-cooked by removing their surface bran layer.

4. The process set forth in claim 1 whereby the raw, whole cereal grains are selected from the group consisting of whole raw, unmodified rice grains, oat grains and wheat grains, and combinations thereof.

5. The process set forth in claim 1 which further comprises adding to the fluid-milk commercial starches and gums such as waxy rice flour and CMC and combinations thereof.

6. The process set forth in claim 1 which further comprises adding to the fluid-milk flavors such as, fruit flavors, cheese, yogurt, vanilla, chocolate, sugar, sweeteners, herbs, spices, and combinations thereof.

7. The process set forth in claim 1 which further comprises adding to the fluid-milk a blend of 85% distilled monoglycerides and 15% lecithin.

8. The process set forth in claim 1 which further comprises forming shaped units by the following steps: a) dumping the entire batch of partially-cooked, modified cereal grains having uncooked grain-centers, from the batch cooker onto the continuous width of a three to six foot wide continuous conveyor-belt; b) moving said wide sheet of grains towards the cutters; c) reducing the height of said sheet of grains by compression with a large roll to a predetermined height; and d) cutting said sheet of grains into bar-shaped units with rotary and guillotine cutters.

9. The process set forth in claim 1 which further comprises depositing with a four to six foot wide Double-Roll Former, numerous parallel strips of partially-cooked modified cereal grains having uncooked grain-centers which are then cut into units with a guillotine cutter.

10. The process set forth in claim 1 which further comprises heating the units in a continuous convection oven with blown air having temperatures ranging from 375 F to 475 F.

11. A process for making grain-textured milk and cereal bars and finger-foods with milk-infused grains having water-activities higher than 0.90 and moistures higher than 25%; said process comprising the steps of:
a) modifying all the raw whole cereal grains that take longer than 30 minutes to become fully-cooked by cutting them into grain-halves so they can become fully-cooked within 30 minutes;
b) cooking in a steam-jacketed, tilt-type kettle every one to four ounces of raw, modified and unmodified cereal grains with every one half-cup of un-pasteurized fluid-milk at 210 F until said fluid-milk is pasteurized and infused into the surface areas of the grains, thereby making sticky-surfaced, partially-cooked, milk-infused cereal grains which are then immediately dumped from the cooker before said fluid-milk diffuses into and gelatinizes the starch-granules in the centers of the grains;
c) depositing said partially-cooked grains having grain-centers that are not gelatinized into continuous sheets which are then cut into units;
d) heating with 450 F blown-air in a continuous convection-oven, said units comprised of partially-cooked grains, so that the infused fluid-milk from the surface areas of the grains diffuses into and continues cooking the grains while their moisture levels are simultaneously reduced, but remain higher than 25%, and then discharging said units from the oven after the starch-granules in the grain-centers have become gelatinized; and
e) freezing said units.

12. The process of claim 11 which further comprises modifying all the raw whole cereal grains that take longer than 30 minutes to become fully-cooked by flattening them to half their thickness so they can become fully-cooked within 30 minutes

13. The process of claim 11 which further comprises modifying raw, whole cereal grains requiring cooking-times longer than 30 minutes to be fully-cooked by removing their surface bran layer.

14. The process set forth in claim 11 whereby raw, whole cereal grains are selected from the group consisting of whole raw, unmodified rice grains, oat grains and wheat grains, and combinations thereof.

15. The process set forth in claim 11 which further comprises adding to the fluid-milk flavors such as, fruit flavors, cheese, yogurt, vanilla, chocolate, sugar, sweeteners, herbs, spices, and combinations thereof.

16. The process set forth in claim 11 which further comprises adding to the fluid-milk commercial starches and gums such as waxy rice flour and CMC and combinations thereof.

17. The process set forth in claim 11 which further comprises adding to the fluid-milk a blend of 85% distilled monoglycerides and 15% lecithin.

18. The process set forth in claim 11 which further comprises the steps of: a) dumping from the batch cooker the entire batch of partially-cooked, modified cereal grains having uncooked grain-centers, across the entire width of a continuous conveyor-belt; b) moving said sheet of grains towards the cutters; c) reducing the height is said sheet of grains by compression with a large roll to a predetermined height; and cutting said sheet of grains into bar-shaped units with rotary and guillotine cutters.

19. The process set forth in claim 11 which further comprises depositing with a four to six foot wide Double-Roll Former, numerous parallel strips of partially-cooked modified cereal grains having uncooked grain-centers which are then cut into units with a guillotine cutter.

20. The process set forth in claim 11 which further comprises heating the units in a continuous convection oven with blown air having temperatures ranging from 375 F to 475 F.
